(19) United States
(12) Patent Application Publication
(10) Pub. No.: US 2007/0217488 A1
(43) Pub. Date: Sep. 20, 2007

(54) METHOD AND DEVICE FOR PROCESSING AN INCIDENT SIGNAL RECEIVED BY A FULL-DUPLEX TYPE DEVICE

(75) Inventors: Lydi Smaini, Saint-Julien-En-Genevois (FR); Pierre Baudin, Grenoble (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignees: STMicroelectronics N.V., Amsterdam (NL); STMicroelectronics SA, Montrouge (FR)

(21) Appl. No.: 11/685,356

(22) Filed: Mar. 13, 2007

(30) Foreign Application Priority Data
Mar. 17, 2006 (EP) 06290437.0

(51) Int. Cl. H04L 5/16

(52) U.S. Cl. 375/219

(57) ABSTRACT

A correction signal is generated by applying an adjustable gain/attenuation value and an adjustable phase value to a transmission signal sampled on the transmission channel after the transmission frequency transposition. The correction signal is subtracted from the signal present on the receive channel before performing the receiver frequency transposition. Digital information representative of the subtracted signal is generated, and the value of gain/attenuation and the value of phase are adjusted in such a manner as to reduce or minimize the digital information.

### FIELD OF THE INVENTION

The invention relates generally to wireless communications systems, notably systems of the full-duplex type, and more particularly to Code Division Multiple-Access-Frequency Division Duplex (CDMA-FDD) systems. The invention relates more particularly to the minimization of the signal leakage or “TX leakage” from the transmission channel towards the receive channel.

### BACKGROUND OF THE INVENTION

In a wireless communications system, a base station communicates with a plurality of remote terminals, such as cellular mobile telephones. FDMA (Frequency-Division Multiple Access) systems and TDMA (Time Division Multiple Access) systems are the traditional multiple access schemes for delivering simultaneous services to a certain number of terminals. The basic idea underlying the FDMA and TDMA systems includes dividing up the available resource into several frequencies or into several time intervals, respectively, in such a manner that several terminals can operate simultaneously without causing interference.

Telephones operating according to the GSM standard belong to the FDMA and TDMA systems in the sense that the transmission and the reception are effected at different frequencies and also at different time intervals. In contrast to these systems using a frequency division or a time division, CDMA (Code Division Multiple Access) systems allow multiple users to share a common frequency and a common time channel by using a coded modulation. Examples of CDMA systems include the CDMA 2000 system, the WCDMA (Wideband CDMA) system or the IS-95 standard.

In CDMA systems, as is well known to those skilled in the art, a ‘scrambling code’ is associated with each base station which allows one base station to be distinguished from another. In addition, an orthogonal code, known by those skilled in the art as an Orthogonal Variable Spreading Factor (OVSF) Code, is allocated to each remote terminal (such as for example a cellular mobile telephone). All the OVSF codes are orthogonal to one another, which allows one remote terminal to be distinguished from another.

Before transmitting a signal over the transmission channel towards a remote terminal, the signal has been scrambled and spread by the base station using the scrambling code of the base station and the OVSF code of the remote terminal. In CDMA systems, the systems referred to as ‘full-duplex systems’ that use different frequencies for the transmission and the reception (CDMA-FDD system), so as to transmit and receive simultaneously, and those that use a common frequency for the transmission and the reception, but separate temporal ranges for transmitting and receiving (CDMA-FDD systems), may be further differentiated.

The invention may be advantageously applied to communications systems of the full-duplex type and, more particularly, to systems of the CDMA-FDD type. A device of the full-duplex type can transmit and receive information simultaneously. Generally speaking, such a device comprises a transmission channel and a receive channel coupled via a duplexer to a common antenna.

Although the duplexer is a component that allows a certain isolation between the transmission channel and the receive channel, a part of the transmitted signal generally leaks from the transmission channel towards the receive channel via the duplexer. Such a leakage signal, also known as “TX leakage”, may thus cause interference detrimental to the correct decoding of the received signal. Moreover, the non-linearity of the components of the receive channel, such as for example the frequency transposition stage, together with the potential interaction of the leakage signal with a scrambling signal, generally creates distortion or inter-modulation components that are located within the band of the useful signal.

One approach for overcoming the effects of the leakage signal includes using filters of the surface acoustic wave type (SAW filters) generally disposed between the low-noise amplifier and the frequency transposition stage of the receive channel. However, the use of such filters limits the possibility for integrating the receiver onto a single chip, requires the use of discrete components for the matching at the input and at the output of the various chips, and increases the cost of the total system.

The published patent application U.S. 2005/0107051 describes another approach for solving this problem of the effects of the leakage signal. This other approach, which is entirely analog, is based on an analog adaptive filtering including an estimation of the leakage signal and a subtraction of this estimated leakage signal on the receive channel. Nevertheless, such an approach requires the analog construction of an adaptive estimator comprising multipliers, integrators and filters. Consequently, this leads to a construction that is relatively complex and costly to implement.

### SUMMARY OF THE INVENTION

The invention provides an approach to the problem of the leakage signal between the transmission channel and the receive channel in a full-duplex type device.

According to one aspect, the invention provides a method for processing an incident signal received by a full-duplex type device comprising a receive channel within which a receiver frequency transposition, an analog-digital conversion of the transposed signal and a digital processing of the converted signal are effected. This device also comprises a transmission channel within which a transmission frequency transposition is effected.

According to a general feature of this aspect of the invention, a correction signal is generated by applying an adjustable gain value and an adjustable phase value to a transmission signal sampled on the transmission channel after the transmission frequency transposition, this correction signal is subtracted from the signal present on the receive channel before the receiver frequency transposition is effected, digital information representative of the subtracted signal (result of the subtraction) is generated, and the gain value and the phase value are adjusted in such a manner as to minimize the digital information.

Thus the invention notably provides, in combination, the generation of digital information on which minimization digital processing will be performed, until a corresponding value of gain and of phase are obtained, in such a manner as to reduce or eliminate the leakage signal within the signal present on the receive channel before the frequency transposition.

Such an approach is particularly simple to implement. One reason for this is that the generation of the digital information and the determination of the minimum of the digital information, and consequently the corresponding values of gain and of phase, can be implemented using all or part of the already-existing components of the digital unit of the device.

Furthermore, as discussed with respect to the invention, the term “gain” is used in the wider sense and encompasses the notion of amplification gain or attenuation. Generally speaking, in this type of full-duplex system, such as is the case for example in WCDMA-FDD systems, the transmitted power is much higher than the received power. Accordingly, the gain value is generally an attenuation value. In addition, in its analog part, the invention provides a simple variable attenuator and a simple phase-shifter.

Several variations are possible for the generation of the digital information. In a first variation, the digital information simply results from the analog-digital conversion of the transposed subtracted signal with a transposition frequency equal to the transmission frequency. In other words, according to this variation of the invention, the generation of the digital information comprises a transposition of the subtracted signal (signal resulting from the subtraction) with a transposition frequency equal to the transmission frequency, and an analog-digital conversion of the transposed subtracted signal; the gain value and the phase value are then adjusted until a value of the digital information is obtained that is less than a threshold close to zero.

This minimized digital information is then simply the power of the leakage signal remaining in the receive channel, before the receiver transposition stage. This power has been reduced or minimized as much as possible by the adjustment of the gain and of the phase of the signal sampled on the transmission channel.

According to a second variation of the invention, the digital information is a digital estimation of a baseband component of a second-order intermodulation signal present on the receive channel, which estimation is performed after the analog-digital conversion. The inventors have indeed observed that estimating the level of this baseband second-order intermodulation component then reducing or minimizing this estimate by adjusting the gain value and the phase value applied to the transmission signal sampled before subtraction on the receive channel, allowed the power of the leakage signal present in the received signal before the receiver frequency transposition to be reduced or minimized. In fact, this estimated baseband component of the second-order intermodulation signal is an image of the power of the leakage signal before the receiver frequency transposition.

By comparison with the conventional approach of the prior art in which the leakage signal is analog filtered in the same way as any other external interference-causing signal (by a ‘blocker’), the invention here uses the fact that the characteristics of this perturbation (the leakage signal) are known since the data transmitted over the transmission channel is known. Consequently, this variation of the invention here advantageously uses this deterministic behavior of the leakage signal to digitally estimate an image of it and reduce or minimize it. Indeed, this deterministic behavior makes the leakage signal completely different from any other unknown interference-causing signal and this variant of the invention uses this difference to an advantage.

The inventors have thus observed that the digital estimation of the level of this baseband second-order intermodulation component of the receive channel could readily be obtained from the data on the transmission channel, in particular from the sum of the squares of the two transmission signal components respectively sampled on the channels I and Q of the transmission channel in the digital processing unit of the device.

In other words, according to one embodiment of the invention, in which the transmission channel also comprises a digital unit comprising two branches in phase quadrature and a digital-analog conversion stage, the generation of the digital information includes the summation of the squares of two signal components respectively sampled on the two branches so as to obtain a summed digital signal, the generation of a reference digital signal from the summed digital signal, and the estimation of the digital information by an adaptive digital filtering involving the reference digital signal and a baseband digital signal sampled on the receive channel after the analog-digital conversion.

The reference digital signal can be directly the summed digital signal. However, the generation of the reference digital signal may comprise a digital filtering with a digital filter corresponding to the various filters of the receive channel. The processing for the generation of the reference digital signal can also comprise an adaptation with a gain correction value representative of the transmission power. This allows the elementary variations in transmission power to be more easily taken into account and the convergence time of the estimation to be reduced. Therefore, according to this second variation of the invention, the digital information (the baseband second-order intermodulation component) is estimated and the gain value and the phase value, applied before subtraction from the sampled transmission signal, are adjusted in such a manner as to minimize it.

In a third variation of the invention, the gain and phase value are adjusted so as to minimize the digital information, but this estimated digital information may also be subtracted from the converted signal, in other words from the digital signal of the receive channel, before this subtracted signal is re-injected into the receive channel. In other words, the gain and phase adjustment leading to the reduction or minimization of the digital information allows the power of the leakage signal to be reduced or minimized before frequency transposition, and the subtraction of this digital information on the receive channel within the digital processing unit of the device allows this residual power to be reduced or eliminated, at least in part. This combination of a gain and phase adjustment and of a subtraction in digital mode of the estimated digital information thus allows the rejection of the leakage signal to be further improved.

Generally, a signal amplification is performed before the receiver frequency transposition. In this case, and whichever variation of the invention is used, the subtraction is preferably performed between the amplification and the receiver frequency transposition. Nevertheless, this subtraction could also be carried out before the amplification, but the corresponding amplification coefficient should then be taken into account.

Furthermore, when a power pre-amplification then a power amplification are effected on the transmission channel after the transmission frequency transposition, which is generally the case, the adjustable gain value and the adjustable phase value are preferably applied to the transmission signal sampled on the transmission channel between the power pre-amplification and the power amplification. Although it would be possible to perform this sampling after the power amplification, sampling after the power pre-amplification, whichever variation of the invention is used, allows the approach of the invention to be readily integrated onto the same chip as that used for the rest of the device, with the exception of the power amplifier which is fabricated on a separate chip.

The incident signal is, for example, received by a device belonging to a CDMA system.

According to another aspect, the invention also provides a device of the full-duplex type, comprising a receive channel able to receive an incident signal and comprising a receiver frequency transposition stage, an analog-digital conversion stage and a unit for digital processing of the converted signal, and a transmission channel comprising a transmission frequency transposition stage.

According to a general feature of this other aspect of the invention, the device includes a first generator or generation means having a first input connected to a location on the transmission channel situated after the transmission frequency transposition stage, a second input able to receive an adjustable gain value and an adjustable phase value, and an output capable of delivering a correction signal. A substractor or subtraction means has a first input connected to a location on the receive channel situated before the receiver frequency transposition stage, a second input connected to the output of the first generation means, and an output for delivering a subtracted signal. A second generator or generation means is capable of generating digital information representative of the subtracted signal, and a processor or processing means is capable of delivering and of adjusting the gain value and the phase value in such a manner as to reduce or minimize the digital information.

According to a variation of the invention, the second generation means may comprise a block or means for transposing the subtracted signal with a transposition frequency equal to the transmission frequency, a block or means for analog-digital conversion of the transposed subtracted signal and the processing means are capable of adjusting the gain value and the phase value until a value of the digital information, less than a threshold close to zero, is obtained.

According to another variation of the invention, the second generation means are capable of performing a digital estimation of a baseband component of a second-order intermodulation signal present on the receive channel so as to obtain the digital information.

According to one embodiment of the invention, the transmission channel also comprises a digital unit comprising two branches in phase quadrature, and an digital-analog conversion stage, and the second generation means comprises: a calculation block or means having two inputs respectively connected to the two branches and capable of performing the summation of the squares of the two signal components respectively present at the two inputs, and an output for delivering a summed digital signal; an intermediate block or means capable of generating a reference digital signal from the summed digital signal; and an adaptive digital filter able to receive the reference signal and a baseband digital signal sampled on the receive channel after the analog-digital conversion stage, and of delivering the estimated digital information. The intermediate means may comprise a digital filter corresponding to the various filters of the receive channel, and/or a correction block or means capable of correcting the summed digital signal with a gain correction value representative of the transmission power.

According to yet another variation of the invention, the digital processing unit of the receive channel may also comprise an additional subtraction block or means having a first input connected to the output of the analog-digital conversion stage, a second input able to receive the estimated digital information and an output capable of delivering the subtracted signal onto the receive channel.

According to one embodiment of the invention, compatible with all the other variations of the latter, the receive channel also comprises an amplifier connected upstream of the receiver frequency transposition stage, and the subtraction means are connected between the amplifier and the receiver frequency transposition stage.

According to another embodiment of the invention, also compatible with all the variants, the transmission channel also comprises a power pre-amplifier connected downstream of the transmission frequency transposition stage and followed by a power amplifier, and the first input of the first generation means is connected to a location in the transmission channel situated between the power pre-amplifier and the power amplifier.

The device according to the invention may belong to a CDMA system and form a terminal, for example a cellular mobile telephone.

### BRIEF DESCRIPTION OF THE DRAWINGS

Other advantages and features of the invention will become apparent upon examining the detailed description of non-limiting embodiments and examples, and the appended drawings.

FIG. 1 is a schematic diagram illustrating a first embodiment of a device according to the invention.

FIG. 2 is a flow chart illustrating the main steps of a first embodiment of a method according to the invention.

FIGS. 3, 4 and 6-8 are schematic diagrams illustrating a second embodiment and implementation of the invention.

FIG. 5 is a flowchart illustrating an implementation of the second embodiment and the invention

FIGS. 9 and 10 are schematic diagrams illustrating a third embodiment and implementation according to the invention.

### DETAILED DESCRIPTION OF THE PREFERRED EMBODIMENTS

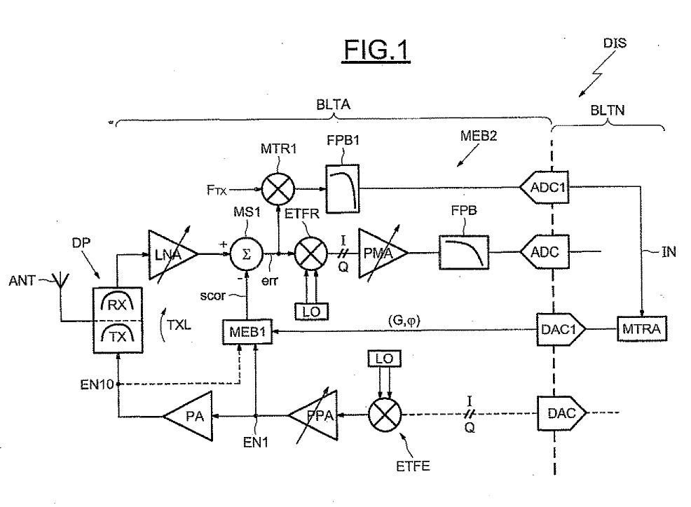

In FIG. 1, the reference DIS denotes a remote terminal, such as a cellular mobile telephone, which is in communication with a base station, for example according to a communications scheme of the CDMA-FDD type. The cellular mobile telephone typically comprises an analog unit BLTA connected to an antenna ANT via a duplexer DP for receiving an incident signal on the receive channel RX.

The receive channel comprises a low-noise amplifier LNA, a receiver frequency transposition stage ETFR followed, in the present case, by a post-mixing variable-gain amplifier. A low-pass filter FPB, for eliminating the mixing residues, is connected between the amplifier PMA and an analog-digital conversion stage ADC. This conversion stage ADC connects the analog unit BLTA to a digital processing unit BLTN.

This digital processing unit BLTN may conventionally include a receiver commonly referred to by those skilled in the art as a “RAKE receiver”, followed by a conventional demodulator or demodulation means that carry out the demodulation of the constellation delivered by the RAKE receiver. The frequency transposition stage ETFR actually comprises two mixers which respectively receive, from a phase-locked loop, two transposition signals LO that are mutually phase-shifted by 90°. After this frequency transposition (effected here for example directly in baseband), the receive channel comprises two branches respectively defining a stream I (direct stream) and a stream Q (quadrature stream) as is well known to those skilled in the art.

As far as the transmission channel TX is concerned, this is conventionally comprised of a transmission frequency transposition stage ETFE so as to perform the transposition from baseband towards the transmission frequency. This transmission frequency transposition stage EFTE is followed here by a variable-gain power pre-amplifier PPA, itself connected to a power amplifier PA whose output is connected to the duplexer DP.

In view of the transmission powers specified for the WCDMA standard, the presence of a power amplifier PA after the power pre-amplifier is generally necessary. Moreover, this power amplifier is generally fabricated on a separate chip, for example using AsGa technology. In contrast, as far as the power pre-amplifier PPA is concerned, this is fabricated on the same chip as that incorporating all the other components of the device DIS, with the exception of the duplexer. In Europe, in the WCDMA standard, the transmission frequency is in the range between 1920 and 1980 MHz, whereas the receiver frequency is in the range between 2110 and 2170 MHz. Of course, these frequency ranges may vary according to country.

The device DIS is termed ‘full-duplex’, which means that the reception of the incident signal and the transmission of a signal are effected simultaneously. Furthermore, a high-power signal must generally be transmitted while a low-power signal is being received. The duplexer DP is a component that also allows the transmission channel TX to be isolated from the receive channel RX. However, this isolation is not perfect and results in a leakage signal TXL (for “TX leakage”) from the transmission channel towards the receive channel.

The embodiment in FIG. 1 is a first approach according to the invention that allows the level of this leakage signal TXL to be reduced or minimized in the signal present on the receive channel before the receiver frequency transposition stage ETFR. More precisely, the device DIS comprises a first generation block or means MEB1 having a first input connected to a location EN1 on the transmission channel situated after the transmission frequency transposition stage ETFE.

In the present case, the location EN1 is situated between the power pre-amplifier PPA and the power amplifier PA. This has the advantage of being able to incorporate the generation means MEB1, together with the other components of the invention allowing the level of the leakage signal to be reduced or minimized, onto the same chip as that used for the fabrication of the components of the device DIS with the exception of the power amplifier PA and of the duplexer DP. Nevertheless, it would also be possible according to the invention for this location EN10 to be situated after the power amplifier PA.

The first generation means MEB1 may also comprise a second input able to receive an adjustable gain value G and an adjustable phase value φ. The first generation means MEB1 may also comprise an output capable of delivering a correction signal scor. The first generation means may comprise, for example, a variable gain amplifier/attenuator and a phase-shifter, which are known per se.

The device also comprises a subtraction block or means MS1 having a first input connected to a location on the receive channel situated before the frequency transposition stage, a second input connected to the output of the first generation means MEB1 and an output for delivering a subtracted signal err, which is in fact related to an error signal. In the present case, the subtraction means MS1 is situated between the low-noise amplifier LNA and the receiver frequency transposition stage ETFR. Nevertheless, it would be possible to put the subtraction means MS1 before the low-noise amplifier LNA.

The device DIS may further comprise a second generation block or means MEB2 capable of generating a digital information IN representative of the subtracted signal err. Lastly, a processor or processing means MTRA is capable of delivering and of adjusting the gain value G and the phase value φ in such a manner as to reduce or minimize this digital information IN.

More precisely, the second generation means here may comprise a frequency transposition block or means MTR1 for the subtracted signal. These transposition means MTR1 comprise an input for receiving the subtracted signal err and another input for receiving the transposition signal F_{TX}. The transposition frequency of the signal F_{TX} is equal to the frequency of the transmission signal such that, after transposition, the subtracted signal is transposed into baseband.

The second generation means here preferably comprise a low-pass filter FPB1 so as to eliminate the mixing residues. The filtered signal is converted in an analog-digital converter ADC1 so as to obtain the digital information IN. This analog-digital converter ADC1 can be the analog-digital converter generally used for the power measurement (for the power control of the transmission channel) or else a separate analog-digital converter. The subtracted signal err is actually an error signal that is representative of the leakage signal level after subtraction and before frequency transposition.

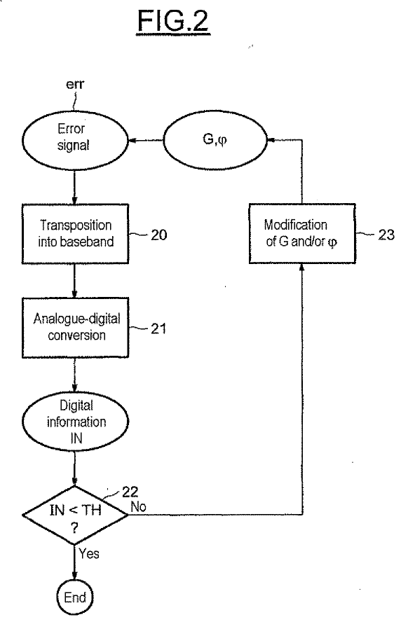

As illustrated in FIG. 2, for a gain value G and a phase value φ, there is a certain level of the signal err. After transposition into baseband 20 and analog-digital conversion 21, the digital information IN is obtained which is compared with a threshold TH (step 22). This threshold TH is chosen to be close to zero. The residual level of the leakage signal admissible in view of the application envisaged will depend on the value of this threshold. Those skilled in the art will therefore know how to choose this threshold TH as a function of the desired residual level of leakage signal.

For as long as the digital information is not less than the threshold TH, the value of the gain G and/or the value of the phase φ will be modified (step 23) and the steps 20, 21 and 22 will be repeated until the digital information IN is reduced or minimized, in other words until digital information IN less than the threshold TH is obtained.

The level of the subtracted signal err (or error signal) is directly linked to the difference in gain between the correction signal scor and the signal output from the low-noise amplifier LNA, and also to the phase difference between these two signals. In practice, given that the device knows the transmission power required by the base station, and that the various attenuation and amplification coefficients of the components of the device DIS are furthermore known, the reduction or minimization of the digital information IN may include simply fixing in advance a value of gain (attenuation) G taking into account the required transmission power, and in varying the value of phase φ until the digital information IN is less than the threshold TH. In practice, the different values of gain (of attenuation) G and of phase φ are for example stored in digital form in a table accessible by the processing means MTRA.

The processing means MTRA therefore extract from the table a gain value G ostensibly corresponding to the correct value of gain taking into account the required transmission power and the various coefficients of gains and attenuations of the components of the system, and also extract various phase values corresponding to this stored gain value. This digital gain (attenuation) and phase information is converted into analog information by a digital-analog converter DAC1 before being respectively sent to the variable attenuator and the phase-shifter of the first generation means MEB1.

The processing means MTRA then continue this phase extraction until digital information less than the desired threshold is obtained. By way of example, a minimum rejection of 20 dB of the leakage signal corresponds to a gain difference of 1 dB and to a phase difference less than 3° between the two signals respectively present at the two inputs of the subtractor MS1. Such a mismatch between the levels and the phases of these two signals is readily compatible with the technology normally used for the fabrication of integrated circuits.

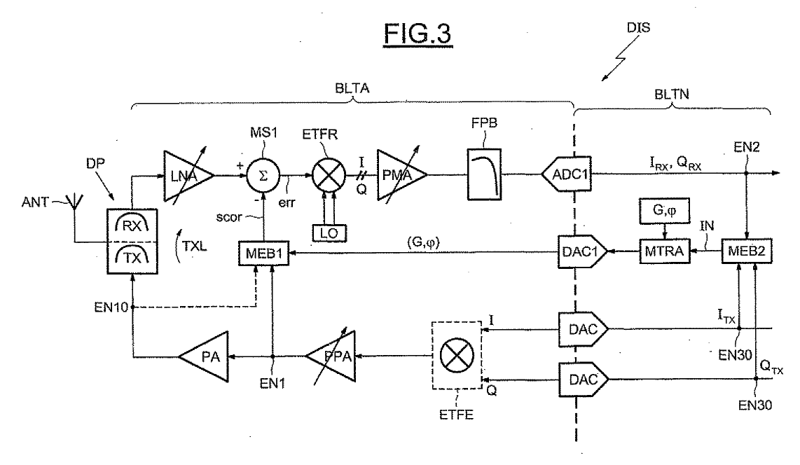

FIG. 3 illustrates a second embodiment of a device according to the invention in which the second generation block or means MEB2 this time are entirely digital and fabricated within the digital processing unit BLTN of the device. The first generation means MEB1, together with the subtractor MS1, are analogous to the corresponding components or means that have been described with reference to FIG. 1.

The receive channel comprises components exhibiting a second-order non-linearity, in other words whose transfer function F may be expressed in the form:

y(t)=α₁x(t)+α₂x²(t)

in which x(t) denotes the input signal and y(t) the output signal from the device. Such a device exhibiting a second-order non-linearity is for example the reference frequency transposition stage ETFR.

Considering a modulated complex incident radiofrequency signal x(t), represented by the following formula:

x(t)=I(t) cos (ω₀t)−Q(t) sin (ω₀t)

then, at the output of the device exhibiting a second-order non-linearity, the signal y(t) according to the following definition is obtained:

$$y ( t ) = {α}_{1} x ( t ) + \frac{{α}_{2}}{2} ( {I}^{2} ( t ) + {Q}^{2} ( t ) ) + \frac{{α}_{2}}{2} [ ( {I}^{2} ( t ) - {Q}^{2} ( t ) ) cos ( 2 {ω}_{0} t ) - 2 I ( t ) Q ( t ) sin ( 2 {ω}_{0} t ) ]$$

It can therefore be seen that the output signal from this device comprises a linear component proportional to the input signal and a second-order intermodulation signal having a baseband component proportional to the square of the modulus of the initial complex modulation, together with a frequency-dependent component at the frequency ω₀. Also, if the input signal is the leakage signal TXL, the linear component, together with the 2ω₀ component, will be filtered notably by the post-mixing low-pass filter FPB.

On the other hand, the baseband component of the second-order intermodulation signal will be combined with the baseband component of the received signal after transposition to the reception frequency in the transposition stage ETFR. Furthermore, when this second-order intermodulation signal is potentially combined with an external interference-causing signal (or ‘blocker’) it may also create third-order intermodulation components. All these intermodulation components turn out to be detrimental to the correct decoding of the received useful signal.

In the embodiment in FIG. 3, the second generation means MEB2 will perform a digital estimation of the baseband component of the second-order intermodulation signal present on the receive channel so as to obtain the said digital information IN. In other words, here, this digital information IN is the baseband component of the second-order intermodulation signal of the receive channel. Indeed, the inventors have observed that this estimated baseband component of the second-order intermodulation signal formed an image of the leakage signal present at the input of the receiver frequency transposition stage.

Then, as will be explained in detail hereinbelow, once this digital information IN has been generated, the processing means MTRA will try to reduce or minimize it by adjusting the gain and phase values applied by the first generation means MEB1 to the signal sampled on the transmission channel in an analogous manner to what has been described with reference to FIG. 1. The second generation means MEB2 here comprise two inputs EN30 respectively connected to the two branches I_{TX} and Q_{TX} Of the digital transmission channel and another input connected to a location EN2 of the receive channel, and more precisely to a location EN2 of one or the other of the channels I_{RX} or Q_{RX} of the receive channel.

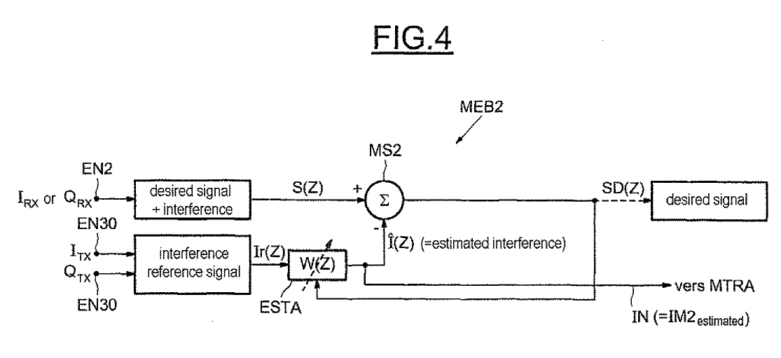

As illustrated in FIG. 4, the generation means MEB2 will use an adaptive digital filter comprising an adaptive estimator ESTA and a subtractor MS2. The subtractor receives at a first input the desired signal S to which an interference has been added (here the baseband component of the second-order intermodulation signal) and, at its other input, an estimation of this interference produced by the adaptive estimator. This adaptive estimator ESTA estimates this interference from a reference signal for the interference, which is obtained from the signal components sampled at the locations EN30, and from the output of the subtractor. The output of the subtractor MS2 delivers the desired signal stripped of the interference SD.

The reference signal is a signal that exhibits a non-zero correlation function with the interference. Furthermore, since the adaptive filter will try to remove everything that is correlated with the reference signal within the signal S, it will also try to remove any portion of the desired signal that might be found within the reference signal. However, in the present case, this is irrelevant since the reference signal is generated using only signal components sampled on the transmission channel.

In the variant in FIG. 3, the output of the adaptive estimator supplies the digital information which here is equal to the estimated baseband component of the second-order intermodulation signal. In this variant, the desired signal delivered at the output of the subtractor MS2 is not injected onto the receive channel. It will also be seen that, in another variant of the invention, the desired signal delivered at the output of the subtractor will also be able to be re-injected onto the receive channel in combination with the estimation and the reduction or minimization of the baseband intermodulation component.

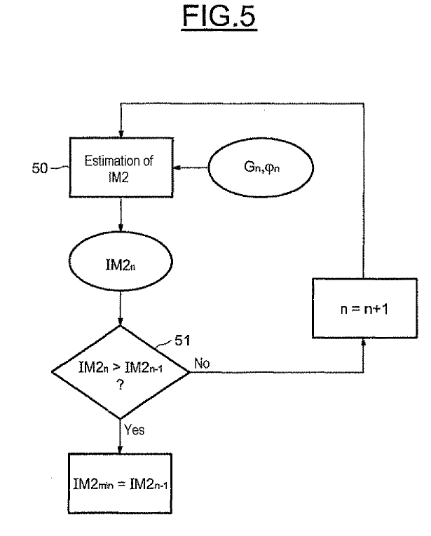

The implementation of the invention corresponding to the embodiment in FIGS. 3, 4, 6, 7 and 8 is illustrated schematically in the flowchart of FIG. 5. Using a value of gain (attenuation) Gn and of phase φn delivered to the first generation means MEB1, the second generation means MEB2 carry out an estimation of the level of the baseband component IM2 of the second-order intermodulation signal (step 50) and deliver an estimated value IM2ₙ of the level of this second-order intermodulation baseband component.

To reduce or minimize this digital information IM2ₙ, the processing means MTRA will, for example, simply compare (step 51) this value IM2ₙ with the value IM2ₙ₋₁ previously calculated for other gain and phase values. If the current value is greater than the preceding value, then the processing means will, in an analogous manner to what has been described with reference to FIG. 1, vary the gain and/or the phase (the phase is normally varied for a fixed gain value) to obtain a new estimated value. If this new estimated value is greater than the preceding estimated value, then the minimum value of the baseband intermodulation level IM2ₘᵢₙ is equal to the previously calculated value, and the desired values of gain G and of phase φ have been obtained. Such processing means MTRA, capable of implementing this minimization process, can be readily obtained by software within the processor in baseband of the device, for example.

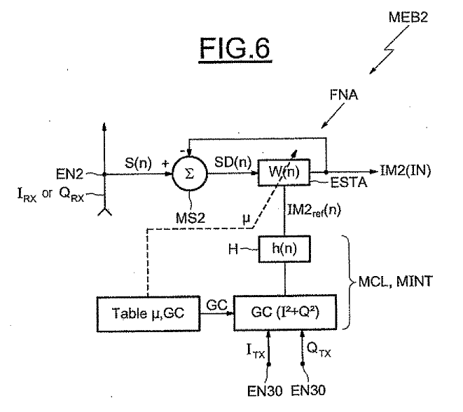

Reference is now more particularly made to FIGS. 6 to 8 to describe the second generation block or means MEB2 in more detail. These second generation means MEB2 comprise a calculation block or means MCL having two inputs respectively connected to the locations EN30 and capable of performing the summation of the square of the two signal components respectively present at these two locations EN30. The output of the adder ADD of the calculation means MCL thus delivers a summed digital signal SNS.

The second generation means MEB2 also comprise an intermediate block or means MINT capable of generating a reference digital signal IM2_{ref} from the summed digital signal SNS. These intermediate means MINT, which can in any case be optional, will be considered in more detail hereinbelow.

The second generation means MEB2 may also comprise an adaptive digital filter FNA able to receive the reference signal IM2_{ref} and a baseband digital signal sampled on the receive channel at the location EN2, for example on the channel I_{RX} (although it would also be possible to sample it on the channel Q_{RX}). The adaptive digital filter is then capable of delivering the estimated digital information IM2 which here forms the digital information IN that the processing means MTRA will try to reduce or minimize.

The adaptive digital filter FNA comprises an adaptive estimator ESTA, together with a subtractor MS2. The adaptive estimator can use a least-squares algorithm for reducing or minimizing the residual mean-square error, in other words the power of the error. Such an estimator using a least-squares algorithm is known per se. By way of example, the final equation leading to an iterative implementation is given by the formula (1) below:

\vec{W}(n+1)=\vec{W}(n)+μSD(n)\vec{IM2}_{ref}(n) (1)

in which:

\vec{W}(n)=[W₀(n) . . . W_{N-1}(n)] (2)

and in which:

\vec{IM2}_{ref}(n)=[IM2_{ref}(n) . . . IM2_{ref}(n−N+1)] (3)

### Here, N is the length of the adaptive filter.

The parameter μ is a parameter guaranteeing the convergence of the algorithm. This parameter must satisfy the following inequalities:

0<μ<2/Nσ²IM2_{ref}

in which σ²IM2_{ref} denotes the variance of the interference reference signal. This variance value can readily be determined from the desired transmission power, which is known by the device.

For this reason, a table is provided in which the various values of μ are stored that are suitable for convergence and stability of the algorithm for various values of the transmission power. In practice, this table could, for example, contain 10 values for the variable μ corresponding to 10 steps of 1 dB for the 10 dB of the range of maximum transmission power.

The intermediate block or means MINT are now considered in more detail. The intermediate block or means allows the reference signal IM2_{ref} to be determined from the summed signal SNS. An optional first adaptation includes assigning a gain (attenuation) value GC to the summed digital signal SNS as a function of the transmission power variation. In fact, this gain adaptation is optional because it simply allows a faster convergence of the adaptive estimator.

Similarly, it is preferable, but not absolutely necessary, for the intermediate means to comprise a digital filter corresponding to the various filters (analog and digital) of the receive channel. For this purpose, the digital filter H may comprise a filter referred to as a ‘Root Raised Cosine’ filter and referenced RRCL, well known per se to those skilled in the art, and having the particular property that its pulse response passes through zero at the symbol frequency. The filter H may also comprise a high-pass filter FLT assuming that such a filter is of course present in the receive channel.

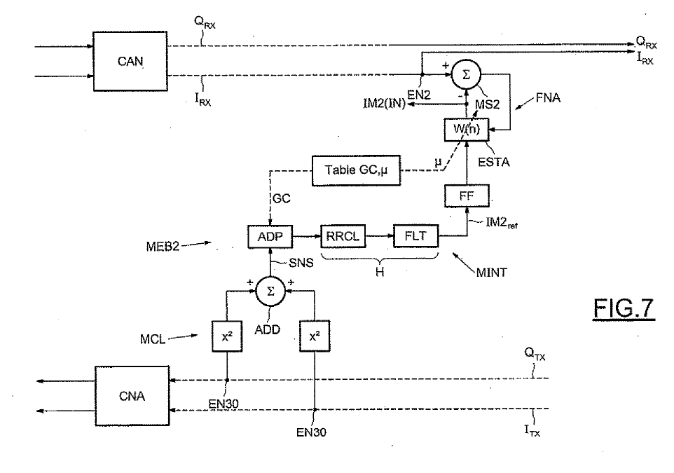

Finally, in the embodiment illustrated in FIG. 7, a memory FF of the first-in/first-out type (FIFO) is used for reasons of synchronization.

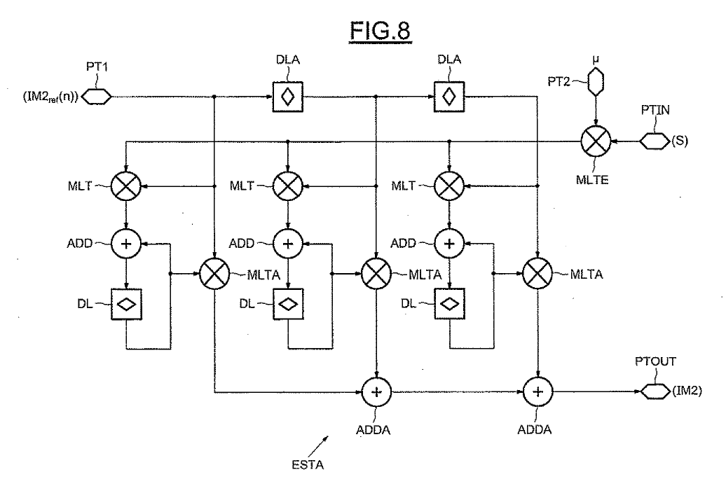

FIG. 8 illustrates one possible embodiment of the adaptive estimator EFTA using a least-squares algorithm with three coefficients. The adaptive estimator ESTA in FIG. 8 consequently comprises a first input port PT1 for receiving the reference signal IM2_{ref}, a second port PT2 for receiving the parameter μ, a third port PTIN for receiving the signal S sampled at the location 2 of the receive channel, and an output port PTOUT for delivering the digital information IN, in other words here the estimated baseband component of the second-order intermodulation signal.

The adaptive estimator here generally includes three identical or substantially identical branches each formed from a multiplier MLT, from an adder ADD and from a delay block or means DL capable of delaying by one sample. These three components MLT, ADD and DL are connected in series at the output of an input multiplier MLTE whose two inputs are respectively connected to the ports PT2 and PTIN.

The output of the delay means DL of each of the branches is connected to another multiplier MLTA and also to the input of the adder ADD of the branch. This multiplier MLTA is connected to the port PT1 either directly, or via other delay means DLA that are analogous to the delay means DL. Lastly, the outputs of the three multipliers MLTA are summed (adders ADDA) before being delivered to the output port PTOUT.

The embodiment described in FIGS. 3 to 8 also allows a rejection of at least 20 dB to be readily obtained for the leakage signal TXL while, at the same time, allowing the constraints on the second-order non-linearity of the receiver frequency transposition stage to be relinquished. This embodiment also allows the third-order intermodulation components to be reduced or minimized.

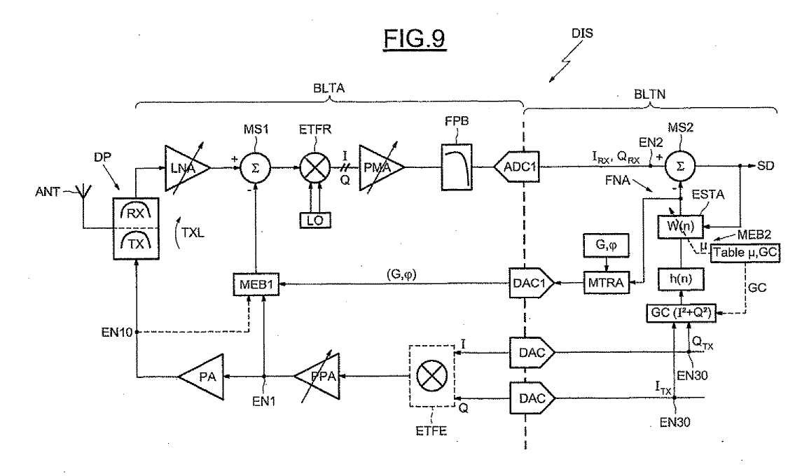

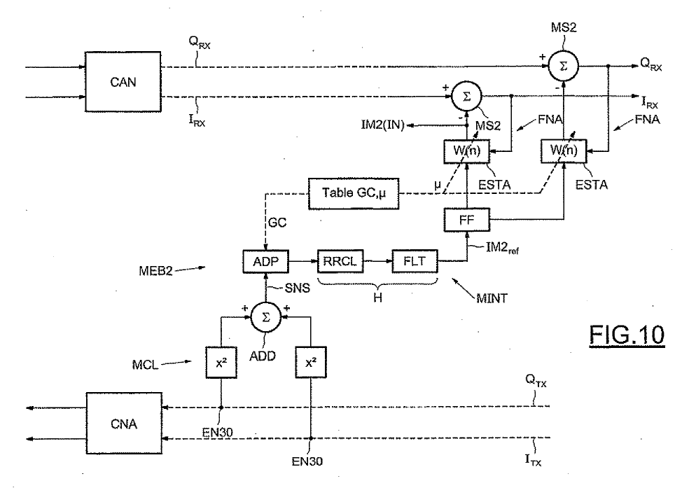

The embodiment in FIGS. 9 and 10 also allows the second-order intermodulation level of the receive channel to be estimated, then to be reduced or minimized in an analogous manner to what has been described with reference to FIGS. 3 to 8, but in this embodiment, this estimated digital information is additionally subtracted from the digital signal coming from the analog-digital converter ADC, the subtracted signal SD resulting from the subtraction being delivered on the receive channel.

Indeed, in the embodiment in FIGS. 3 to 8, the desired signal SD, in other words the signal stripped of the second-order intermodulation baseband component, is not re-injected into the receive channel. In other words, as illustrated in FIG. 9, the subtractor MS2 this time forms an integral part of the receive digital channel so as to deliver the subtracted signal SD on this receive channel.

More precisely, as illustrated in FIG. 10, the digital filter FNA is duplicated so as to be able to re-inject, onto each of the branches I_{RX} and Q_{RX} of the receive channel, the signal SD stripped of the second-order intermodulation baseband component in baseband. Thus, this embodiment in FIGS. 9 and 10 uses, in combination, an estimation of the baseband component of the second-order intermodulation signal and a reduction or minimization in such a manner as to inject, upstream of the receiver frequency transposition stage, a signal with the leakage signal almost totally removed, and a second elimination of the residual second-order intermodulation baseband component in the digital part.

This allows the level of the intermodulation components combined with the baseband useful signal of the receive channel to be still further reduced.

1-21. (canceled)

22. A method for processing an incident signal received by a full-duplex type communications device including a receive channel and a transmission channel, the method comprising:
performing a receiver frequency transposition of the incident signal, an analog-digital conversion of the transposed signal and a digital processing of the converted signal within the receive channel;
performing a transmission frequency transposition within the transmission channel;
generating a correction signal by applying an adjustable gain/attenuation value and an adjustable phase value to a transmission signal sampled on the transmission channel after the transmission frequency transposition;
subtracting the correction signal from a signal present on the receive channel before the receiver frequency transposition is performed to define a subtracted signal;
generating digital information representative of the subtracted signal; and
adjusting the gain/attenuation value and the phase value to reduce the digital information.

23. A method according to claim 22, wherein generating the digital information comprises a transposition of the subtracted signal with a transposition frequency related to the transmission frequency, and an analog-digital conversion of the transposed subtracted signal; and wherein the gain value and the phase value are adjusted to obtain a value of the digital information less than a threshold.

24. A method according to claim 23, wherein generating the digital information further comprises a digital estimation of a baseband component of a second-order intermodulation signal present on the receive channel, the estimation being performed after the analog-digital conversion.

25. A method according to claim 22, wherein the transmission channel also comprises a digital unit comprising two branches in phase quadrature and an analog-digital conversion stage; and wherein generating the digital information comprises:
the summation of squares of two signal components respectively sampled on the two branches so as to obtain a summed digital signal;
the generation of a reference digital signal from the summed digital signal; and
the estimation of the digital information by an adaptive digital filtering based upon the reference digital signal and a baseband digital signal sampled on the receive channel after the analog-digital conversion.

26. A method according to claim 25, wherein the generation of the reference digital signal comprises a digital filtering with a digital filter corresponding to filters of the receive channel.

27. A method according to claim 25, wherein the generation of the reference digital signal comprises an adaptation with a gain/attenuation correction value representative of a transmission power.

28. A method according to claim 25, wherein the estimated digital information is also subtracted from the analog-to-digital converted signal, and the resulting signal is re-injected into the receive channel.

29. A method according to claim 22, further comprising a signal amplification performed before the receiver frequency transposition; and wherein the subtraction is performed between the amplification and the frequency transposition.

30. A method according to claim 22, further comprising a power pre-amplification then a power amplification performed on the transmission channel after the transmission frequency transposition; and wherein the adjustable gain value and the adjustable phase value are applied to a transmission signal sampled on the transmission channel between the power pre-amplification and the power amplification.

31. A method according to claim 22, wherein the full-duplex type communications device comprises a CDMA device receiving the incident signal.

32. A full-duplex type communications device comprising:
a receive channel to receive an incident signal and comprising a receiver frequency transposition stage, an analog-digital conversion stage and a digital processing unit for digital processing of the converted signal;
a transmission channel comprising a transmission frequency transposition stage;
a first generation block having a first input connected to a location on the transmission channel positioned after the transmission frequency transposition stage, a second input to receive an adjustable gain value and an adjustable phase value, and an output to deliver a correction signal;
a subtraction block having a first input connected to a location on the receive channel positioned before the receiver frequency transposition stage, a second input connected to an output of the first generation block, and an output to deliver a subtracted signal;
a second generation block to generate digital information representative of the subtracted signal; and
a processor to deliver and adjust the gain value and the phase value to reduce the digital information.

33. A device according to claim 32, wherein the second generation block comprises a transposition block to transpose the subtracted signal with a transposition frequency related to the transmission frequency, and an analog-digital converter to convert the transposed subtracted signal; and wherein the processor adjusts the gain value and the phase value until a value of the digital information is less than a threshold.

34. A device according to claim 32, wherein the second generation block performs a digital estimation of a baseband component of a second-order intermodulation signal present on the receive channel, so as to obtain the digital information.

35. A device according to claim 32, wherein the transmission channel also comprises a digital unit comprising two branches in phase quadrature, and an analog-digital conversion stage; and wherein the second generation block comprises a calculation block having two inputs respectively connected to the branches to perform the summation of the squares of the two signal components respectively present at the two inputs, and an output for delivering a summed digital signal, an intermediate block to generate a reference digital signal from the summed digital signal, and an adaptive digital filter to receive the reference signal and a baseband digital signal sampled on the receive channel after the analog-digital conversion stage, and to deliver the estimated digital information.

36. A device according to claim 35, wherein the intermediate block comprises a digital filter corresponding to filters of the receive channel.

37. A device according to claim 35, wherein the intermediate block comprises a correction block to correct the summed digital signal with a gain/attenuation correction value representative of a transmission power.

38. A device according to claim 37, wherein the digital processing unit of the receive channel further comprises an additional subtraction block having a first input connected to the output of the analog-digital conversion stage, a second input to receive the estimated digital information and an output capable of delivering a resulting signal onto the receive channel.

39. A device according to claim 38, wherein the receive channel further comprises an amplifier connected upstream of the receiver frequency transposition stage; and wherein the subtraction block is connected between the amplifier and the receiver frequency transposition stage.

40. A device according to claim 32, wherein the transmission channel further comprises a power pre-amplifier connected upstream of the transmission frequency transposition stage and followed by a power amplifier, and the first input of the first generation block is connected to a location in the transmission channel positioned between the power pre-amplifier and the power amplifier.

41. A device according to claim 32, wherein the full-duplex type communications device defines a CDMA device.

42. A device according to claim 32, wherein the CDMA device defines a cellular mobile telephone.

43. A CDMA cellular mobile communications device comprising:
a receive channel to receive an incident signal and comprising a receiver frequency transposition stage;
a transmission channel comprising a transmission frequency transposition stage;
a first generation block having a first input connected to the transmission channel after the transmission frequency transposition stage, a second input to receive an adjustable gain value and an adjustable phase value, and an output to deliver a correction signal;
a subtraction block having a first input connected to the receive channel before the receiver frequency transposition stage, a second input connected to an output of the first generation block, and an output to deliver a subtracted signal;
a second generation block to generate a digital signal representative of the subtracted signal; and
a processor to deliver and adjust the gain value and the phase value to affect the digital signal.

44. A device according to claim 43, wherein the second generation block comprises a transposition block to transpose the subtracted signal with a transposition frequency related to the transmission frequency, and an analog-digital converter to convert the transposed subtracted signal; and wherein the processor adjusts the gain value and the phase value until a value of the digital signal is less than a threshold.

45. A device according to claim 43, wherein the second generation block performs a digital estimation of a baseband component of a second-order intermodulation signal present on the receive channel, so as to obtain the digital signal.

46. A device according to claim 43, wherein the transmission channel further comprises a power pre-amplifier connected upstream of the transmission frequency transposition stage and followed by a power amplifier, and the first input of the first generation block is connected to the transmission channel between the power pre-amplifier and the power amplifier.
